(19) United States
(12) Patent Application Publication
(10) Pub. No.: US 2024/0175756 A1
(43) Pub. Date: May 30, 2024

(54) MICRO-BOLOMETER AND THERMAL SENSING METHOD THEREOF

(71) Applicant: SONIX Technology Co., Ltd., Hsinchu (TW)

(72) Inventors: Chien-Liang Lin, Hsinchu (TW); Chen-Liang Li, Hsinchu (TW)

(73) Assignee: SONIX Technology Co., Ltd., Hsinchu (TW)

(21) Appl. No.: 18/519,080

(22) Filed: Nov. 27, 2023

(30) Foreign Application Priority Data
Nov. 28, 2022 (TW) 111145479

(51) Int. Cl. G01J 5/24

(52) U.S. Cl. CPC G01J 5/24; G01J 2005/202

(57) ABSTRACT

A micro-bolometer and a thermal sensing method thereof are provided. Each of switching circuits switches connection relationship between a first connection point or a second connection point of a corresponding thermal sensing pixel and different signal transmission lines and a shared connection line, so as to adjust the connection mode of the thermal sensing pixels, the first signal transmission line, the second signal transmission line and the at least one shared connection line, and thus to change a sensing signal provided by the thermal sensing pixels.

### CROSS-REFERENCE TO RELATED APPLICATION

This application claims the priority benefit of Taiwan application serial no. 111145479, filed on Nov. 28, 2022. The entirety of the above-mentioned patent application is hereby incorporated by reference herein and made a part of this specification.

### BACKGROUND

### Technical Field

The disclosure relates to a sensing device, and in particular to a micro-bolometer and a thermal sensing method thereof.

### Description of Related Art

A micro-bolometer is a thermal sensor which uses an array composed of multiple micro-bolometer pixels to measure radiant energy and converts it into an electrical signal as output. Generally speaking, after the micro-bolometer array is packaged, the connection mode between the micro-bolometer pixels is fixed and cannot be changed. In other words, the characteristics of the micro-bolometer array are fixed and cannot be adjusted in accordance with the characteristics of the post-stage circuit. For example, the sensing signal provided by the micro-bolometer array cannot be adjusted in accordance with the dynamic range of the post-stage circuit. Therefore, the micro-bolometer has less flexibility when used.

### SUMMARY

The disclosure provides a micro-bolometer and a thermal sensing method thereof, which greatly improve the flexibility of use of the micro-bolometer.

The micro-bolometer of the disclosure includes multiple thermal sensing pixels and multiple switching circuits. Each of the thermal sensing pixels has a first connection point and a second connection point. The switching circuits are respectively coupled to a first signal transmission line, a second signal transmission line, at least one shared connection line, and the first connection point or the second connection point of the corresponding thermal sensing pixel to switch connection relationship between the first connection point or the second connection point of the corresponding thermal sensing pixel and the first signal transmission line, the second signal transmission line and the at least one shared connection line, so as to adjust a connection mode of the thermal sensing pixels, the first signal transmission line, the second signal transmission line and the at least one shared connection line, thereby changing a sensing signal provided by the thermal sensing pixels. The thermal sensing pixels and the switching circuits are jointly formed on a silicon substrate through a semiconductor manufacturing process.

In an embodiment of the disclosure, the micro-bolometer further includes a sensing circuit and a signal processing circuit. The sensing circuit is coupled to the first signal transmission line and the second signal transmission line, and performs a signal amplification processing on the sensing signal. The signal processing circuit is coupled to the sensing circuit and performs an analog to digital conversion processing on the sensing signal provided by the sensing circuit.

In an embodiment of the disclosure, the micro-bolometer further includes a control circuit coupled to the switching circuits, and controlling the switching circuits to adjust the connection mode of the thermal sensing pixels according to a dynamic range of the signal processing circuit.

In an embodiment of the disclosure, the connection mode of the thermal sensing pixels includes at least one of a series connection, a parallel connection, and a disconnection.

In an embodiment of the disclosure, the thermal sensing pixels further include reference pixels.

The disclosure also provides a thermal sensing method of a micro-bolometer. The micro-bolometer includes multiple thermal sensing pixels and multiple switching circuits. Each of the thermal sensing pixels has a first connection point and a second connection point. The thermal sensing method of the micro-bolometer includes the following. The switching circuits are provided. The switching circuits are connected to a first signal transmission line, a second signal transmission line, at least one shared connection line, and the first connection point or the second connection point of the corresponding thermal sensing pixel. The switching circuits are controlled to switch connection relationship between the first connection point or the second connection point of the corresponding thermal sensing pixel and the first signal transmission line, the second signal transmission line and the at least one shared connection line, so as to adjust the connection mode of the thermal sensing pixels, the first signal transmission line, the second signal transmission line and the at least one shared connection line, thereby changing a sensing signal provided by the thermal sensing pixels. The thermal sensing pixels and the switching circuits are jointly formed on a silicon substrate through a semiconductor manufacturing process.

In an embodiment of the disclosure, the sensing signal generated by the thermal sensing pixels is transmitted to a signal processing circuit to perform an analog to digital conversion processing.

In an embodiment of the disclosure, the thermal sensing method of the micro-bolometer includes controlling the switching circuits to adjust the connection mode of the thermal sensing pixels according to a dynamic range of the signal processing circuit.

In an embodiment of the disclosure, the connection mode of the thermal sensing pixels includes at least one of a series connection, a parallel connection, and a disconnection.

In an embodiment of the disclosure, the thermal sensing pixels include micro-bolometer pixels.

In an embodiment of the disclosure, the thermal sensing pixels further include reference pixels.

Based on the above, the micro-bolometer according to the embodiments of the disclosure may switch connection relationship between the first connection point or the second connection point of the thermal sensing pixel corresponding to each of the switching circuits and different signal transmission lines and the shared connection line, so as to adjust the connection mode of the thermal sensing pixels, the first signal transmission line, the second signal transmission line and the at least one shared connection line, and thus to change the sensing signal provided by the thermal sensing pixels, thereby preventing the situation where the micro-bolometer is not able to adjust the connection mode between the thermal sensing pixels after completing the packaging, and greatly improving the flexibility of use of the micro-bolometer.

To make the aforementioned more comprehensible, several embodiments accompanied with drawings are described in detail as follows.

### BRIEF DESCRIPTION OF THE DRAWINGS

FIG. 1 is a schematic top view of a micro-bolometer according to an embodiment of the disclosure.

FIG. 2 is a schematic diagram of a micro-bolometer according to an embodiment of the disclosure.

FIG. 3 is a schematic diagram of a micro-bolometer according to another embodiment of the disclosure.

FIG. 4 is a schematic diagram of a micro-bolometer according to another embodiment of the disclosure.

FIG. 5 is a schematic diagram of a micro-bolometer according to another embodiment of the disclosure.

FIG. 6 is a schematic diagram of a micro-bolometer according to another embodiment of the disclosure.

FIG. 7 is a flow chart of a thermal sensing method of a micro-bolometer according to an embodiment of the disclosure.

### DESCRIPTION OF THE EMBODIMENTS

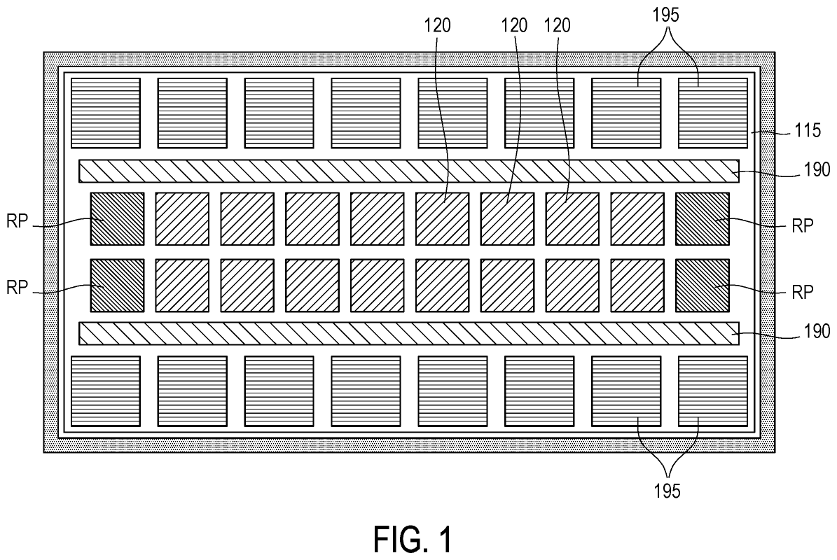

FIG. 1 is a schematic top view of a micro-bolometer according to an embodiment of the disclosure. The micro-bolometer may include multiple thermal sensing pixels (including micro-bolometer pixels 120 and reference pixels RP), multiple signal line setting areas 190, and multiple input/output pads 195. The micro-bolometer pixels 120 and the reference pixels RP are arranged in an array on a silicon substrate 115. In addition, the signal line setting areas 190 and the input/output pads 195 are also disposed on the silicon substrate 115. The micro-bolometer pixels 120 are located between the reference pixels RP. Both the micro-bolometer pixel 120 and the reference pixel RP may be used as the thermal sensing pixels. One or more traces (such as signal transmission lines and shared connection lines, but not limited thereto) may be set in the signal line setting area 190 as required. The signal line setting areas 190 are disposed on the opposite sides of the array formed by the micro-bolometer pixels 120 and the reference pixels RP, and are located between the input/output pads 195 and the array formed by the micro-bolometer pixels 120 and the reference pixels RP. The reference pixel RP has a similar structure to the micro-bolometer pixel 120. A sensing signal provided by the reference pixel RP only reflects basic circuit characteristics, such as material characteristics and electrical signal characteristics of a circuit substrate. The sensing signal provided by the reference pixel RP may be provided to a back-end signal processing circuit for signal processing that removes the basic characteristics of the circuit to obtain more accurate sensing results.

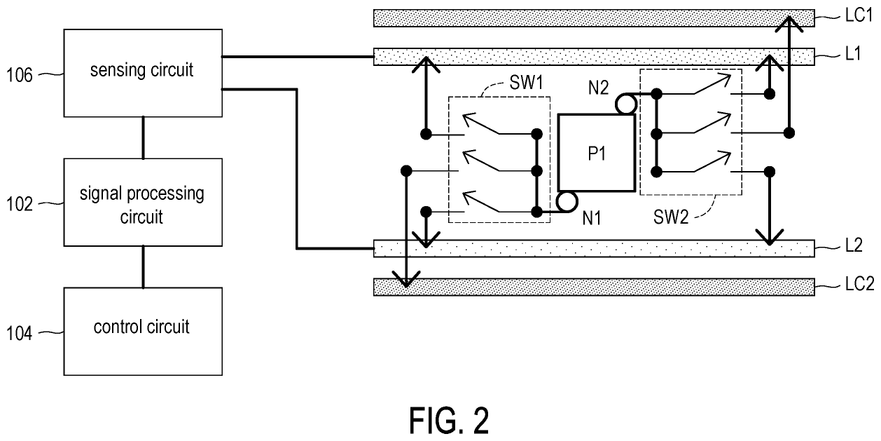

FIG. 2 is a schematic diagram of a micro-bolometer according to an embodiment of the disclosure. To be more specific, the micro-bolometer includes a thermal sensing pixel P1, switching circuits SW1 and SW2, a signal processing circuit 102, a control circuit 104, and a sensing circuit 106. The signal processing circuit 102 is coupled to the control circuit 104. The sensing circuit 106 is coupled to the signal processing circuit 102 and is coupled to the thermal sensing pixel P1 through signal transmission lines L1 and L2 and the switching circuits SW1 and SW2. The thermal sensing pixel P1 and the switching circuits SW1 and SW2 are jointly formed on a silicon substrate through a semiconductor manufacturing process, in other embodiments, the thermal sensing pixel P1, the switching circuits SW1, SW2, the signal processing circuit 102, the control circuit 104, and the sensing circuit 106 may be formed on a silicon substrate. Furthermore, the silicon substrate, the signal processing circuit 102, the control circuit 104, and the sensing circuit 106 are mounted on a printed circuit board and packaged. In some embodiments, the signal processing circuit 102, the control circuit 104, and the sensing circuit 106 may be independent components and may not be packaged together with the silicon substrate.

Further, as shown in FIG. 2, the thermal sensing pixel P1 has a connection point N1 and a connection point N2. The switching circuit SW1 is coupled to the connection point N1, the signal transmission line L1, the signal transmission line L2, and a shared connection line LC2. The switching circuit SW2 is coupled to the connection point N2, the signal transmission line L1, the signal transmission line L2, and a shared connection line LC1. The shared connection lines LC1 and LC2 may be used as bridge lines for connecting different thermal sensing pixels. The switching circuits SW1 and SW2 may be controlled by the control circuit 104 to change the connection state, and select to connect the connection points N1 and N2 to the signal transmission line L1, the signal transmission line L2, the shared connection line LC1, or the shared connection line LC2, thereby changing the connection state of the thermal sensing pixel P1. In this embodiment, the switching circuits SW1 and SW2 are respectively implemented with three switches. By controlling the conduction states of the three switches, the connection points N1 and N2 may be connected to the signal transmission line L1, the signal transmission line L2, the shared connection line LC1, or the shared connection line LC2.

It is worth noting that, for convenience of description, FIG. 2 shows only one thermal sensing pixel P1, but the micro-bolometer includes multiple thermal sensing pixels in actual application. In the case where the micro-bolometer includes multiple thermal sensing pixels, changing a coupling relationship between the thermal sensing pixels may correspondingly change the characteristics of the sensing signal output to the sensing circuit 106. For example, by connecting multiple thermal sensing pixels in series or in parallel, the signal characteristics (for example, magnitude of a voltage) of the sensing signals provided by the thermal sensing pixels to the sensing circuit 106 may be changed. The sensing circuit 106 may perform a signal amplification processing on the sensing signal. The signal processing circuit 102 may, for example, perform an analog to digital conversion processing on the sensing signal provided by the sensing circuit 106, but is not limited thereto.

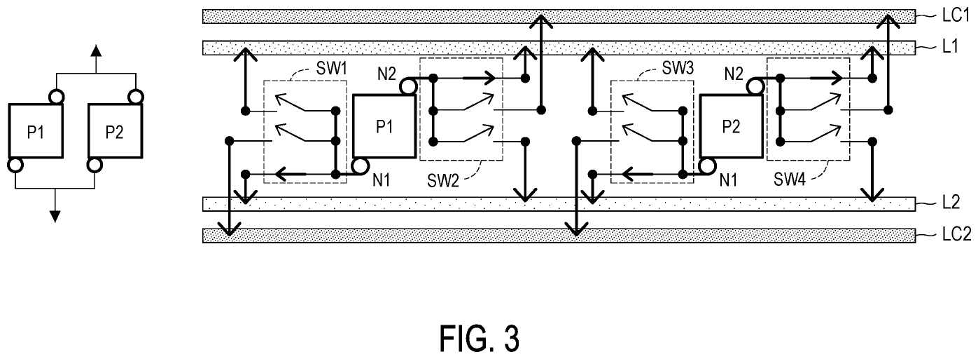

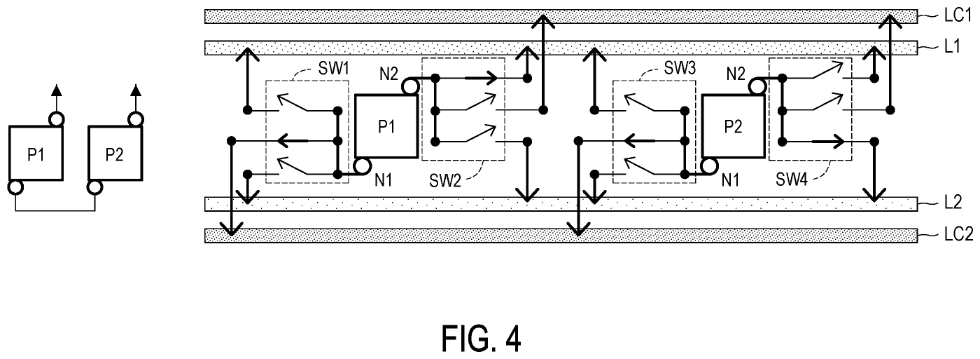

For example, in the embodiments of FIG. 3 and FIG. 4, the micro-bolometer includes two thermal sensing pixels P1 and P2. As shown in FIG. 3 and FIG. 4, the left side of FIG. 3 and FIG. 4 is a schematic diagram of the connection mode of the thermal sensing pixels P1 and P2, and the right side is a circuit structure diagram of the thermal sensing pixels P1 and P2, the switching circuits SW1 to SW4, the signal transmission lines L1 and L2, and the shared connection lines LC1 and LC2.

In the embodiment of FIG. 3, the control circuit 104 controls the switching circuit SW1 to connect the connection point N1 of the thermal sensing pixel P1 to the signal transmission line L2, controls the switching circuit SW2 to connect the connection point N2 of the thermal sensing pixel P1 to the signal transmission line L1, controls the switching circuit SW3 to connect the connection point N1 of the thermal sensing pixel P2 to the signal transmission line L2, and controls the switching circuit SW4 to connect the connection point N2 of the thermal sensing pixel P2 to the signal transmission line L1, so that the thermal sensing pixels P1 and P2 are connected in parallel.

In the embodiment of FIG. 4, the control circuit 104 controls the switching circuit SW1 to connect the connection point N1 of the thermal sensing pixel P1 to the shared connection line LC2, controls the switching circuit SW2 to connect the connection point N2 of the thermal sensing pixel P1 to the signal transmission line L1, controls the switching circuit SW3 to connect the connection point N1 of the thermal sensing pixel P2 to the shared connection line LC2, and controls the switching circuit SW4 to connect the connection point N2 of the thermal sensing pixel P2 to the signal transmission line L2, so that the thermal sensing pixels P1 and P2 are connected in series.

In some embodiments, the control circuit 104 may also control the switching circuit so that some thermal sensing pixels do not participate in providing the sensing signal to the sensing circuit 106. For example, in the embodiment of FIG. 3, the switches of the switching circuits SW1 and SW2 may be configured to be in an off-state, so that only the thermal sensing pixel P2 provides the sensing signal to the sensing circuit 106.

In this way, by connecting the thermal sensing pixels P1 and P2 in series, in parallel, or by disconnecting some of the thermal sensing pixels from the sensing circuit 106, the signal characteristics of the sensing signal provided to the sensing circuit 106 by the thermal sensing pixels P1 and P2 may be changed, making a sensing signal S1 provided by the thermal sensing pixels P1 and P2 more suitable for the signal processing circuit 102 to perform the signal processing. For example, the sensing signal S1 provided by the thermal sensing pixels P1 and P2 may fall within a dynamic range of the signal processing circuit 102, but not limited thereto. In addition, in other embodiments, when there is a thermal sensing pixel that malfunctions or is damaged, the control circuit 104 may disconnect the malfunctioning or damaged thermal sensing pixel from the sensing circuit 106 through controlling the switching circuit corresponding to the malfunctioning or damaged thermal sensing pixel, so that the thermal sensing pixels working normally are connected with each other and bypass the malfunctioning or damaged thermal sensing pixel, thereby preventing the malfunctioning or damaged thermal sensing pixel from affecting the sensing quality of the micro-bolometer.

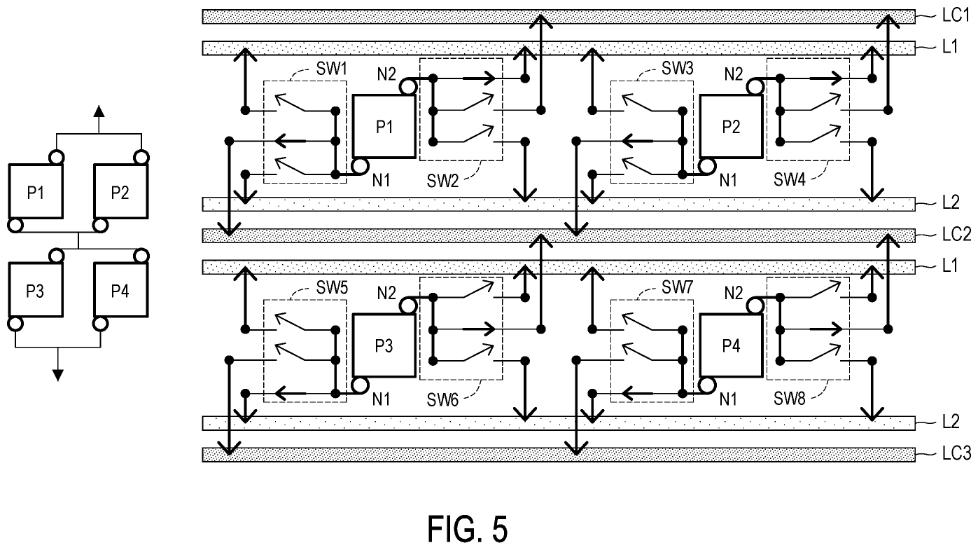

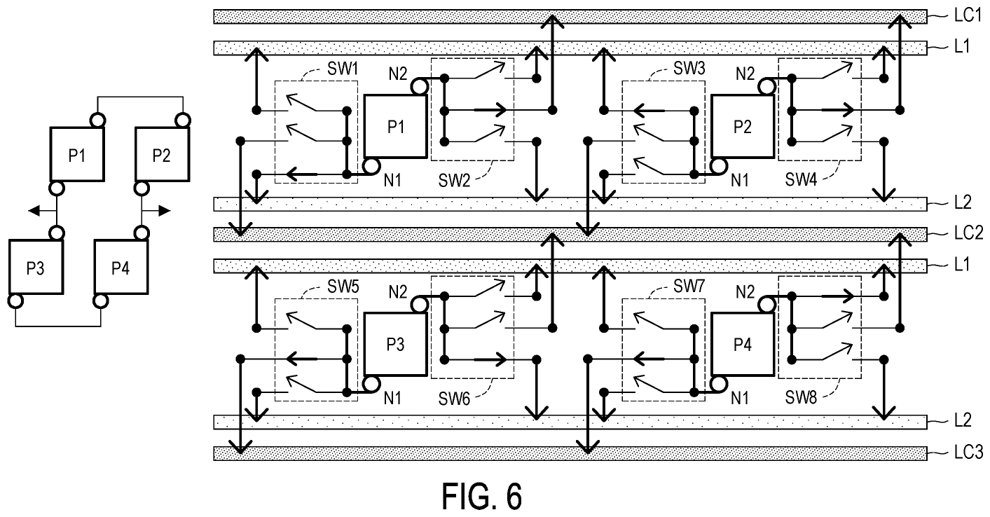

In addition, the number of the thermal sensing pixels included in the micro-bolometer is not limited to the above embodiment. In other embodiments, the micro-bolometer may include more thermal sensing pixels. For example, as shown in the embodiments of FIG. 5 and FIG. 6, the micro-bolometer may include thermal sensing pixels P1 to P4. Similarly, the thermal sensing pixels P1 to P4 are connected to corresponding switching circuits SW1 to SW8. Since the thermal sensing pixels P1 to P4 and the switching circuits SW1 to SW8 are similar to the above embodiment, the coupling relationship will not be repeated here. The switching circuits SW1 to SW8 may be controlled by the control circuit 104 to switch the connection points N1 and N2 of the thermal sensing pixels P1 to P4 to be connected to the signal transmission line L1, the signal transmission line L2, the shared connection line LC1, LC2, or LC3. For example, in the embodiment of FIG. 5, the thermal sensing pixels P1 and P2 connected in parallel and the thermal sensing pixels P3 and P4 connected in parallel may be connected in series. In the embodiment of FIG. 6, the thermal sensing pixels P1 and P2 connected in series and the thermal sensing pixels P3 and P4 connected in series may be connected in parallel.

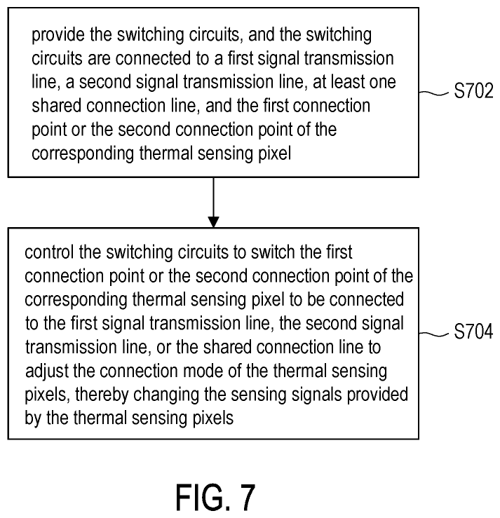

FIG. 7 is a flow chart of a thermal sensing method of a micro-bolometer according to an embodiment of the disclosure. The micro-bolometer includes a plurality of thermal sensing pixels and a plurality of switching circuits. Each of the thermal sensing pixels has a first connection point and a second connection point. The thermal sensing pixels and the switching circuits are jointly formed on a silicon substrate through a semiconductor manufacturing process. As may be seen from the above embodiments, the thermal sensing method of the micro-bolometer may at least include the following. First, the switching circuits are provided, and the switching circuits are connected to a first signal transmission line, a second signal transmission line, at least one shared connection line, and the first connection point or the second connection point of the corresponding thermal sensing pixel (step S702). The sensing signal generated by the thermal sensing pixel is transmitted to the signal processing circuit through the first signal transmission line. The thermal sensing pixel may be, for example, a micro-bolometer pixel, but is not limited thereto. Then, the switching circuits are controlled to switch the first connection point or the second connection point of the corresponding thermal sensing pixel to be connected to the first signal transmission line, the second signal transmission line, or the shared connection line to adjust the connection mode of the thermal sensing pixels, so that the sensing signals provided by the thermal sensing pixels are changed (step S704). For example, the connection mode of the thermal sensing pixels is adjusted by controlling the switching circuits according to the dynamic range of the signal processing circuit. The connection mode of the thermal sensing pixels may include at least one of a series connection, a parallel connection, and a disconnection.

To sum up, the micro-bolometer according to the embodiments of the disclosure may switch connection relationship between the first connection point or the second connection point of the thermal sensing pixel corresponding to each of the switching circuits and different signal transmission lines and shared connection line, so as to adjust the connection mode of the thermal sensing pixels, the first signal transmission line, the second signal transmission line and the at least one shared connection line, and thus to change the sensing signal provided by the thermal sensing pixels, thereby preventing the situation where the micro-bolometer is not able to adjust the connection mode between the thermal sensing pixels after completing the packaging, and greatly improving the flexibility of use of the micro-bolometer.

What is claimed is:

1. A micro-bolometer, comprising:
a plurality of thermal sensing pixels, wherein each of the thermal sensing pixels has a first connection point and a second connection point; and
a plurality of switching circuits, respectively coupled to a first signal transmission line, a second signal transmission line, at least one shared connection line, and the first connection point or the second connection point of the corresponding thermal sensing pixel, switching connection relationship between the first connection point or the second connection point of the corresponding thermal sensing pixel and the first signal transmission line, the second signal transmission line and the at least one shared connection line, so as to adjust a connection mode of the thermal sensing pixels, the first signal transmission line, the second signal transmission line and the at least one shared connection line to change a sensing signal provided by the thermal sensing pixels, wherein the thermal sensing pixels and the switching circuits are jointly formed on a silicon substrate through a semiconductor manufacturing process.

2. The micro-bolometer according to claim 1, further comprising:
a sensing circuit, coupled to the first signal transmission line and the second signal transmission line, and performing a signal amplification processing on the sensing signal; and
a signal processing circuit, coupled to the sensing circuit, and performing an analog to digital conversion processing on the sensing signal provided by the sensing circuit.

3. The micro-bolometer according to claim 2, further comprising:
a control circuit, coupled to the switching circuits, and controlling the switching circuits to adjust the connection mode of the thermal sensing pixels according to a dynamic range of the signal processing circuit.

4. The micro-bolometer according to claim 1, wherein the connection mode of the thermal sensing pixels comprises at least one of a series connection, a parallel connection, and a disconnection.

5. The micro-bolometer according to claim 1, wherein the thermal sensing pixels further comprise a reference pixel.

6. A thermal sensing method of a micro-bolometer, wherein the micro-bolometer comprises a plurality of thermal sensing pixels and a plurality of switching circuits, and each of the thermal sensing pixels has a first connection point and a second connection point, the thermal sensing method of the micro-bolometer comprising:
providing the switching circuits, wherein the switching circuits are connected to a first signal transmission line, a second signal transmission line, at least one shared connection line, and the first connection point or the second connection point of the corresponding thermal sensing pixel; and
controlling the switching circuits to switch connection relationship between the first connection point or the second connection point of the corresponding thermal sensing pixel and the first signal transmission line, the second signal transmission line and the at least one shared connection line, so as to adjust a connection mode of the thermal sensing pixels, the first signal transmission line, the second signal transmission line and the at least one shared connection line to change a sensing signal provided by the thermal sensing pixels, wherein the thermal sensing pixels and the switching circuits are jointly formed on a silicon substrate through a semiconductor manufacturing process.

7. The thermal sensing method of the micro-bolometer according to claim 6, wherein the sensing signal generated by the thermal sensing pixels is transmitted to a signal processing circuit to perform an analog to digital conversion processing.

8. The thermal sensing method of the micro-bolometer according to claim 7, comprising:
controlling the switching circuits to adjust the connection mode of the thermal sensing pixels according to a dynamic range of the signal processing circuit.

9. The thermal sensing method of the micro-bolometer according to claim 6, wherein the connection mode of the thermal sensing pixels comprises at least one of a series connection, a parallel connection, and a disconnection.

10. The thermal sensing method of the micro-bolometer according to claim 8, wherein the thermal sensing pixels comprise a micro-bolometer pixel.

11. The thermal sensing method of the micro-bolometer according to claim 6, wherein the thermal sensing pixels further comprise a reference pixel.
